(19) United States
(12) Patent Application Publication
(10) Pub. No.: US 2021/0197814 A1
(43) Pub. Date: Jul. 1, 2021

(54) VEHICLE AND CONTROLLING METHOD THEREOF

(71) Applicants: HYUNDAI MOTOR COMPANY, Seoul (KR); KIA MOTORS CORPORATION, Seoul (KR); HYUNDAI AUTRON CO., LTD., Seoul (KR)

(72) Inventors: Changwoo Ha, Seoul (KR); Byung-Jik Keum, Seoul (KR); Ho-Jun Kim, Seoul (KR); Jun-Muk Lee, Seongnam-si (KR); Kyunghwan Kang, Suwon-si (KR)

(73) Assignees: HYUNDAI MOTOR COMPANY, Seoul (KR); KIA MOTORS CORPORATION, Seoul (KR); HYUNDAI AUTRON CO., LTD., Seoul (KR)

(21) Appl. No.: 17/033,036

(22) Filed: Sep. 25, 2020

(30) Foreign Application Priority Data
Dec. 30, 2019 (KR) 10-2019-0177852

(51) Int. Cl. B60W 30/14; B60W 30/182; B60W 30/08

(52) U.S. Cl. CPC B60W 30/143; B60W 30/182; B60W 2420/42; B60W 2555/20; B60W 2420/52; B60W 30/08

(57) ABSTRACT

A vehicle is capable of efficient autonomous driving by changing the detection range and power consumption of a sensor according to the speed of the vehicle. The vehicle includes: an information acquirer configured to acquire vehicle surround information; a speed sensor configured to acquire vehicle speed; and a controller configured to determine a vehicle stopping distance based on the vehicle speed and to determine a detection area for acquiring the vehicle surround information by the information acquirer based on the stopping distance and a risk level for each sensor channel The detection area includes the stopping distance relative to the vehicle.

### CROSS-REFERENCE TO RELATED APPLICATION(S)

This application is based on and claims priority under 35 U.S.C. § 119 to Korean Patent Application No. 10-2019-0177852, filed on Dec. 30, 2019, the disclosure of which is incorporated herein by reference in its entirety.

### BACKGROUND

### 1. Technical Field

The present disclosure relates to a vehicle and a controlling method thereof, and more particularly, to a vehicle and a controlling method that perform autonomous driving.

### 2. Description of the Related Art

Recently, autonomous driving controllers used in vehicles require a large amount of data to cover the widest area possible.

To accommodate this data, the use of the latest high-performance controllers consumes significant amounts of power. However, in the near future, when autonomous driving performance is stabilized and electric vehicles and hydrogen cars are more common, this power consumption may be an obstacle to efficient autonomous driving. On the other hand, core usage for processing huge amounts of data may also occur.

### SUMMARY

Therefore, it may become necessary to set a sensing range for efficiently using the core occupancy and power consumption of a vehicle, and to develop an algorithm accordingly.

In view of the above, an aspect of the present disclosure provides a vehicle and a control method thereof capable of efficient autonomous driving by changing the detection range and power consumption of the sensor according to the speed of the vehicle.

In accordance with an aspect of the present disclosure, a vehicle may include: an information acquirer configured to acquire vehicle surround information; a speed sensor configured to acquire vehicle speed; and a controller configured to determine a vehicle stopping distance based on the vehicle speed and to determine a detection area for acquiring the vehicle surround information by the information acquirer based on the stopping distance and a risk level for each sensor channel. The detection area may include the stopping distance relative to the vehicle.

The controller may acquire the vehicle surround information by expanding the detection area to a predetermined extended detection area based on a speed increase of the vehicle speed and the risk level for each sensor channel when the vehicle speed exceeds a predetermined speed.

The controller may perform an autonomous driving algorithm based on the vehicle surround information acquired at the extended detection area.

The controller may acquire the vehicle surround information by reducing the detection area to a predetermined reduced detection area based on a speed decrease of the vehicle speed and the risk level for each sensor channel when the vehicle speed is less than a predetermined speed.

The information acquirer may include a radar sensor and a lidar sensor. The controller may perform a high precision autonomous driving algorithm by changing resolution of the radar sensor and the lidar sensor based on the vehicle speed and the risk level for each sensor channel when the vehicle speed is less than the predetermined speed.

The controller may reduce power consumed in acquiring the vehicle surround information to a predetermined value.

The information acquirer may include at least one camera. The controller may change a maximum viewing distance of each camera of the at least one camera to a predetermined value corresponding to each camera of the at least one camera.

The information acquirer may obtain weather information of a road on which the vehicle travels. The controller may determine the detection area based on the weather information and the vehicle speed.

The information acquirer may include a first sensor and a second sensor. The controller may determine a sensor determined risk level for each sensor channel that has a high risk as the first sensor, determine a sensor determined risk level for each sensor channel that has a low risk as the second sensor, reduce the data acquisition area of the first sensor to a predetermined reduction area, and extend the data acquisition area of the second sensor to a predetermined extension range.

The controller may receive a vehicle driving mode from a user and determine a width of the detection area for acquiring the vehicle surround information based on the vehicle driving mode input by the user.

### BRIEF DESCRIPTION OF THE DRAWINGS

These and/or other aspects of the disclosure will become apparent and more readily appreciated from the following description of the embodiments, taken in conjunction with the accompanying drawings, of which:

FIG. 1 illustrates a control block diagram according to an embodiment;

FIG. 2 is a diagram for describing a relationship between a vehicle speed and a braking distance according to an embodiment.

FIG. 3 is a diagram illustrating an area in which a radar sensor, a lidar sensor, and a camera acquire vehicle surrounding information according to an embodiment.

FIG. 4 is a diagram illustrating an extended detection area and a reduced detection area according to an embodiment.

FIG. 5 is a flowchart illustrating a method or process according to an embodiment.

### DETAILED DESCRIPTION

Like reference numerals refer to like elements throughout. The present disclosure does not describe all elements of the embodiments and overlaps between the general contents or the embodiments in the technical field to which the present disclosure belongs.

This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

In addition, when a part is said to “include” a certain component, this means that it may further include other components, except to exclude other components unless otherwise stated.

Throughout the specification, when a member is located “on” another member, this includes not only when one member is in contact with another member but also when another member exists between the two members.

The terms first, second, and the like are used to distinguish one component from another component, and the component is not limited by the terms described above.

Singular expressions include plural expressions unless the context clearly indicates an exception.

In each step, the identification code or number is used for convenience of description. The identification code or number does not describe the order of each step. Each of the steps may be performed out of the stated order unless the context clearly dictates the specific order.

Hereinafter, with reference to the accompanying drawings, the working principle and embodiments of the present disclosure are described.

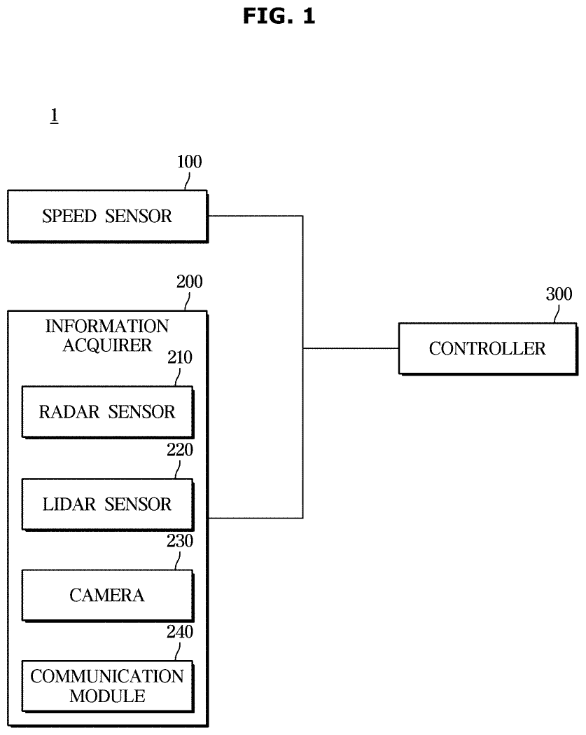

FIG. 1 illustrates a control block diagram according to an embodiment.

Referring to FIG. 1, the vehicle 1 may include an information acquirer 200, a speed sensor 100, and a controller 300.

The information acquirer 200 may acquire information around the vehicle 1, i.e., vehicle surrounding information.

Vehicle surrounding information may mean a form of all information collected by the vehicle 1 to perform autonomous driving. According to an embodiment, it may mean a risk factor that may cause an accident when driving the vehicle 1.

The information acquirer 200 may include a radar sensor 210, a lidar sensor 220, a camera 230, and a communication module 240.

The radar sensor 210 may refer to a sensor that detects a distance, a direction, and an altitude of an object by receiving electromagnetic waves reflected from the object by emitting electromagnetic waves or microwaves (microwave, 10 cm to 100 cm wavelength).

The lidar sensor 220 may refer to a sensor that emits a laser pulse and receives the light reflected from the surrounding object and returned to measure the distance to the object to accurately identify or depict the surroundings.

The camera 230 may be configured to acquire an image around the vehicle 1. According to an embodiment, a camera 230 or multiple cameras may be provided at the front, rear, and side of the vehicle 1 to acquire an image.

The camera 230 installed in the vehicle 1 may include a charge-coupled device (CCD) camera 230 or a complementary metal-oxide-semiconductor (CMOS) color image sensor. In this case, the CCD and the CMOS both refer to a sensor that converts and stores light input through the lens of the camera 230 into an electrical signal. Specifically, the CCD cameras 230 and 110 are devices that convert an image into an electrical signal. In addition, a CIS (CMOS Image Sensor) refers to a low power consumption, low power type imaging device having a CMOS structure. A CIS serves as an electronic film of a digital device. In general, CCD technology is more sensitive than CIS technology and is used in the vehicle 1 but is not necessarily limited thereto.

The communication module 240 may be configured to acquire weather information of a road on which the vehicle 1 travels, as described below.

The communication module 240 may include one or more components that enable communication with an external device. For example, the communication module 240 may include at least one of a short range communication module 240, a wired communication module 240, or a wireless communication module 240.

The speed sensor 100 may obtain speed information of the vehicle 1.

According to an embodiment, the speed sensor 100 may be installed at four wheels, i.e., in the front and rear wheels as a sensor in the wheel to detect the rotational speed of the wheel as a change in the magnetic line of the tone wheel and the sensor. According to an embodiment, the sensor in the wheel may be provided in the vehicle 1 electronic stability control (ESC) system.

The wheel speed sensor 100 may derive the speed and acceleration of the vehicle 1 based on the measured wheel speed.

The controller 300 may determine a detection area in which the information acquirer 200 obtains vehicle surrounding information based on the speed of the vehicle 1.

The detection area may mean an area in which the above-described radar sensor 210, lidar sensor 220, and camera 230 acquire vehicle surrounding information.

In detail, when the speed of the vehicle 1 exceeds the predetermined speed, the controller may expand the detection area to a predetermined extended detection area in response to the speed increase of the vehicle 1 to obtain the vehicle surrounding information. The detection area may mean a changeable area in which the vehicle 1 acquires information around the vehicle 1 through the information acquirer 200.

The extended detection area may mean the widest range in which the information acquirer 200 provided in the vehicle 1 can acquire vehicle surrounding information.

According to an embodiment, the region may be predetermined. Details related to this are described below.

The controller 300 may perform the autonomous driving algorithm based on the vehicle surrounding information obtained in the extended detection region.

The autonomous driving algorithm may mean an algorithm in which the vehicle 1 autonomously travels based on the surrounding information acquired by the vehicle 1.

When the speed of the vehicle 1 is less than the predetermined speed, the controller 300 may reduce the detection area to the predetermined reduction detection area in response to a decrease in the speed of the vehicle 1 to obtain the vehicle surrounding information. In other words, when the speed of the vehicle 1 decreases, there is no need to obtain vehicle surrounding information in a wide area. Thus, the controller 300 can obtain vehicle surrounding information by reducing the detection area.

If the speed of the vehicle 1 is less than the predetermined speed, the controller 300 may increase the resolution of the radar sensor 210 and the lidar sensor 220 to perform a high precision autonomous driving algorithm.

In other words, when the vehicle 1 decreases in speed, there may be a need to acquire more information in a narrow area. Accordingly, the controller 300 may precisely acquire information of the reduced detection area by increasing the resolutions of the radar sensor 210 and the lidar sensor 220 included in the information acquirer 200.

If the speed of the vehicle 1 is less than the predetermined speed, the controller can reduce the power consumed in obtaining the vehicle surrounding information to a predetermined value. In other words, when the speed of the vehicle 1 is relatively low, the controller 300 does not need to acquire information in a wide area. Thus, the controller can reduce power in obtaining information in a small area.

The controller 300 may reduce the maximum viewing distance of the camera 230 or cameras to a predetermined value corresponding to each of the cameras 230.

In other words, a plurality of cameras 230 may be provided in the vehicle 1, and the viewing distance of each camera 230 may be individually determined. On the other hand, the detection area for the vehicle 1 to obtain the surrounding information may be determined by the viewing distance of the cameras 230. Therefore, the controller 300 may reduce the maximum viewing distance of each camera 230 to a predetermined value corresponding to each of the cameras 230.

The information acquirer 200 may acquire weather information of a road on which the vehicle 1 travels.

The controller may determine the detection area based on the weather information and the speed of the vehicle 1.

In other words, when the speed of the vehicle 1 is relatively high, the controller may widen a wide detection area and acquire vehicle surrounding information in the extended detection area. However, the stopping distance of the vehicle 1 may be used to determine the detection area, as described below.

On the other hand, the stopping distance of the vehicle 1 may be changed according to the condition of the road surface on which the vehicle 1 travels in addition to the speed of the vehicle 1. The controller can thus determine the detection area based on the weather information and the speed of the vehicle 1. A detailed description thereof is described below.

The controller may determine, as the first sensor, a sensor that is determined to have a high risk for each sensor channel, and may determine, as the second sensor, a sensor that is determined to have a low risk for each sensor channel.

The first and second sensors are merely names for classifying the information acquirer and are not based on priorities.

The controller may reduce the data acquisition area of the first sensor to a predetermined reduction range. In other words, since the configuration included in the first sensor is not easy to acquire data, the reliability of the amount of data acquired by each configuration is low, thereby reducing the data acquisition area.

The controller can extend the data acquisition region of the second sensor to a predetermined extension range.

Unlike the first sensor, the second sensor has a low risk and thus has high reliability of the acquired data, thereby expanding or extending the acquisition area.

The controller may receive a driving mode of the vehicle from a user and determine an area of a detection area for acquiring the vehicle surrounding information based on the driving mode of the vehicle input by the user.

For example, when a user inputs a command to drive in a high speed driving mode, a large area of data may be detected. When a command for driving in a low speed driving mode is input, data of a narrow area may be detected.

At least one component may be added or deleted to correspond to the performance of the components of the vehicle 1 shown in FIG. 1. In addition, it will be readily understood by those having ordinary skill in the art that the mutual position of the components may be changed corresponding to the performance or structure of the system.

Meanwhile, each component illustrated in FIG. 1 refers to a hardware component, such as software and/or a field programmable gate array (FPGA) and an application specific integrated circuit (ASIC).

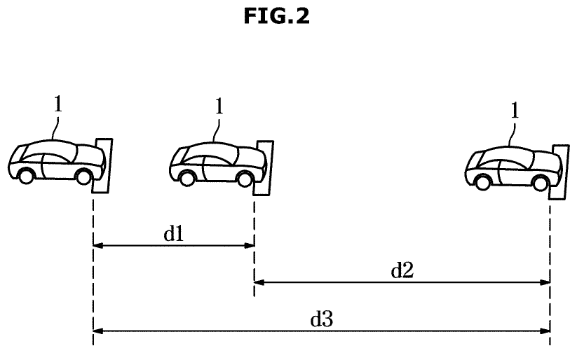

FIG. 2 is a diagram for describing a relationship between a vehicle speed and a braking distance according to an embodiment.

Referring to FIG. 2, the stopping distance of the vehicle 1 may mean a minimum distance that the autonomous vehicle 1 can detect and avoid (stop before hitting) a hazard.

The controller 300 can determine the necessary data acquisition range depending on the vehicle speed.

In other words, since the stopping distance d3 of the vehicle 1 is a distance determined by the vehicle 1 based on the speed, and thus the minimum distance required for the vehicle 1 to stop, the controller 300 may determine the stopping distance d3 based on the speed of the vehicle 1.

According to an embodiment, the controller 300 may determine the stopping distance as the sum of the free running distance d1 and the braking distance d2.

The free running distance d1 is a distance before a person recognizes a risk and takes an action. The free running distance d1 can be interpreted as a time required for the autonomous vehicle 1 to recognize and determine a risk factor. According to an embodiment, the free running time may be determined as about 0.7 to 1.0 second.

The braking distance d2 may be interpreted as the minimum distance required, after braking of the vehicle 1 is performed, that is necessary for braking corresponding to the speed of the vehicle 1.

The braking distance d2 can thus be determined based on the speed of the vehicle 1. Operation related to this is a matter that a person having ordinary skill in the art can derive.

Therefore, the free running distance d1 may be determined as the product of the speed of the vehicle 1 and the free running time.

The controller 300 may determine the free running distance d1 based on the speed of the vehicle 1.

Therefore, the controller 300 may determine the stopping distance d3 of the vehicle 1 based on the traveling speed of the vehicle 1.

In summary, the stopping distance of the vehicle 1 may mean a minimum distance required for stopping the vehicle 1. The controller 300 may determine the stopping distance of the vehicle 1 based on the speed of the vehicle 1.

In addition, the controller 300 may determine the detection area based on the stopping distance determined based on the above-described operation.

The detection area may mean an area for acquiring vehicle surrounding information acquired by the information acquirer 200 provided in the vehicle 1.

The controller 300 may determine the detection area based on the stopping distance determined based on the speed of the vehicle 1. detailed description thereof is described below.

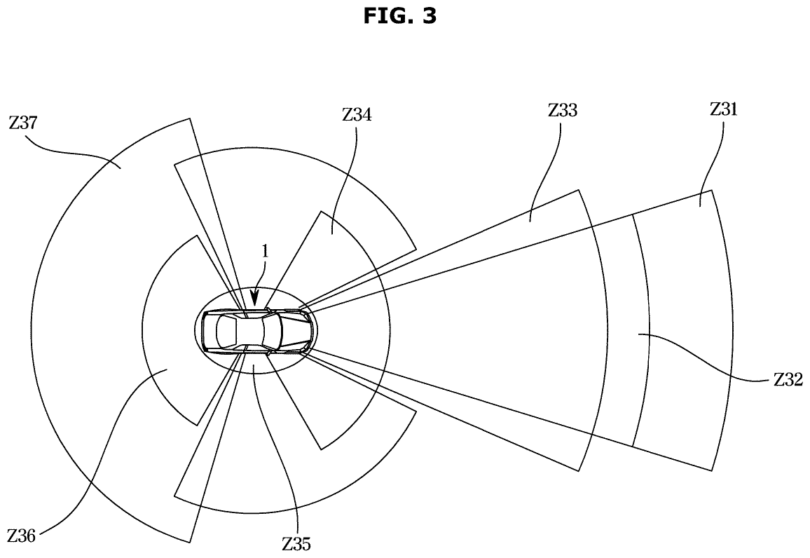

FIG. 3 is a diagram illustrating an area in which a radar sensor 210, a lidar sensor 220, and a camera 230 acquire vehicle surrounding information according to an embodiment.

Referring to FIG. 3, an area is illustrated in which the information acquirer 200 acquires vehicle surrounding information around the vehicle 1.

Specifically, a narrow angle front camera Z31 of the cameras 230 of the vehicle 1 may acquire vehicle 1 information up to a distance of 250 m in front of the vehicle 1.

In addition, a radar sensor Z32 provided in the vehicle 1 may acquire vehicle 1 information up to a distance of 160 m in front of the vehicle 1.

In addition, a main front camera Z33 among the cameras 230 provided in the vehicle 1 may acquire vehicle 1 information up to a distance of 150 m in front of the vehicle 1. Also, the main front camera Z33 may acquire a wider range of information than the narrow front camera 230.

In addition, a wide-angle front camera Z34 among the cameras 230 provided in the vehicle 1 may acquire vehicle 1 information up to a distance of 60 m in front of the vehicle 1. The wide-angle front camera Z34 may acquire vehicle surrounding information in a wider area than the narrow-angle front camera Z31 or the main front camera Z33.

In addition, an ultrasonic sensor Z35 provided in the vehicle 1 may acquire vehicle surrounding information of an 8 m area around the vehicle 1.

On the other hand, a rear side camera Z36 of the cameras 230 provided in the vehicle 1 may acquire the vehicle 1 information up to a distance of 100 m behind the vehicle 1. On the other hand, a rear view camera Z37 facing backward may obtain vehicle 1 information up to a distance of 100 m behind the vehicle 1.

Meanwhile, the region shown in FIG. 3 is only an embodiment of the present disclosure. There is no limitation on the configuration of the information acquirer 200 or the region where the information acquirer 200 acquires vehicle surrounding information.

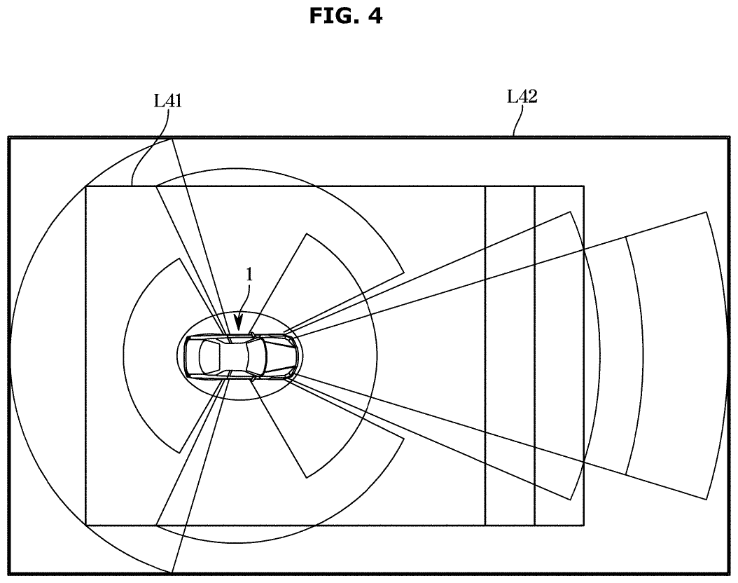

FIG. 4 is a diagram illustrating an extended detection area and a reduced detection area according to an embodiment.

FIG. 4 shows an extended detection area and a reduced detection area based on the vehicle 1 speed determined by the controller 300.

Referring to FIGS. 2-4, in the case of the autonomous vehicle 1 driving at a speed of 60 km, the controller 300 may determine the stopping distance as about 44 m.

The controller 300 can use the sensing data of about 57 m, which is slightly larger than the stopping distance, and apply an appropriate algorithm. In this case, since the detection area does not need to be larger than the existing one, the controller 300 may reduce the detection area to a predetermined reduction detection area L41 to obtain vehicle surrounding information.

The controller 300 can reduce processing load and improve battery efficiency based on the above-described operation.

In this case, the controller 300 acquires high resolution data of a short distance and can perform more precise autonomous driving at low speed.

Meanwhile, the resolution in the present disclosure may refer to the degree of separation between two spectral lines approaching with respect to the radar sensor and the lidar sensor.

Specifically, the radar sensor 210 may have a relatively low resolution in order to recognize a wide distance.

The radar sensor 210 has a higher resolution to recognize a shorter distance, thereby enabling more precise control. The lidar sensor 220 is similarly applicable.

Therefore, when the speed of the vehicle 1 is less than the predetermined speed, the controller 300 may perform a high precision autonomous driving algorithm by increasing the resolution of the radar sensor and the lidar sensor 220.

According to an embodiment, the controller 300 may turn off the narrow angle front camera Z31 of the cameras 230 at a speed of 80 km.

In addition, the controller 300 may reduce the maximum viewing distance of the main front camera Z33 of the cameras 230 to use only shorter distance data. In this case, the controller 300 may reduce the power consumption to a predetermined value as described above to efficiently obtain the surrounding information.

On the other hand, when the vehicle 1 runs over a predetermined speed, the detection area may be set longer than the stopping distance to ensure stability. For example, when the vehicle 1 travels at 100 km/h, the controller 300 may determine a detection area of about 100 m that is greater than the safety distance of 77 m. The controller 300 may predetermine this detection area as the extended detection area L42.

In summary, the controller 300 may reduce and use the detection area L41 of the information acquirer 200 determined to have a low risk by applying a risk determination algorithm for each sensor channel.

Risk is a concept related to the reliability of information obtained from each sensor channel. If the risk is low, data based on a small detection area may be used. If the risk is high, data based on a wide detection area may be used.

On the other hand, the detection area L42 of the information acquirer 200 determined to have a high risk may be used.

In other words, when the vehicle 1 exceeds the predetermined speed, an autonomous driving algorithm may be performed to use an algorithm that uses data of as wide a range as possible. On the other hand, when the speed of the vehicle 1 is less than the predetermined speed, the controller 300 either: calculates the speed of the vehicle 1 and the risk of the information acquirer 200 to determine the detection area to increase the resolution of the sensor to perform a high-precision autonomous driving algorithm; or reduces the power consumed to obtain the surrounding information to a predetermined value.

On the other hand, the operation described in FIGS. 2-4 is only an embodiment of the disclosure. There is no limitation in the operation of determining the area of the surrounding information obtained by the vehicle 1 based on the speed of the vehicle 1.

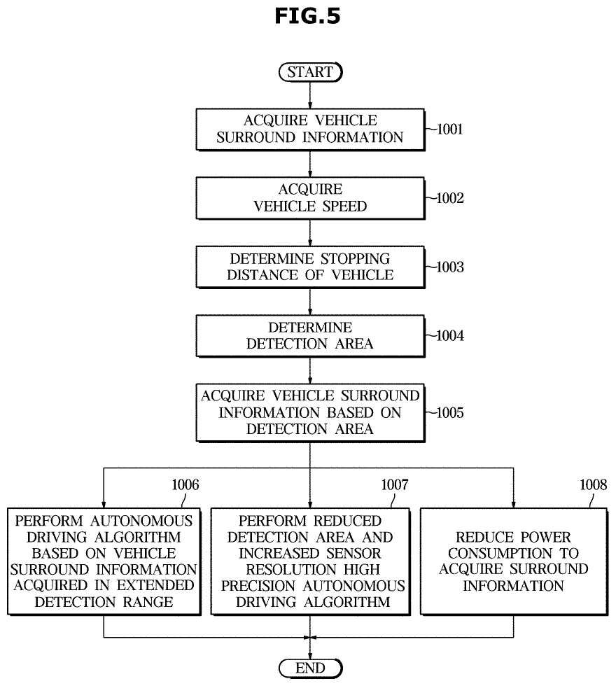

FIG. 5 is a flowchart illustrating a process or method according to an embodiment.

The vehicle 1 may obtain vehicle surrounding information (1001).

In addition, the vehicle 1 may acquire the speed of the vehicle 1 by using a wheel speed sensor (1002).

Based on this, the vehicle 1 may determine a stopping distance of the vehicle 1 (1003) and determine a detection area according to the stopping distance (1004). As described above, if the stopping distance is long, the detection area can be wider, and if the stopping distance is short, the detection area can be narrowed.

Meanwhile, when the detection area is determined, the vehicle 1 may acquire vehicle surrounding information based on the determined detection area (1004).

If the vehicle speed exceeds the predetermined speed, the vehicle may perform the autonomous driving algorithm based on the vehicle surrounding information acquired in the detection area (1005).

Meanwhile, when the speed of the vehicle is less than the predetermined speed, the high resolution autonomous driving algorithm may be performed by increasing the resolution of the radar sensor and the lidar sensor (1006).

In addition, the vehicle may reduce the power consumed in obtaining the vehicle surrounding information to a predetermined value (1007).

On the other hand, the above-mentioned embodiments may be implemented in the form of a recording medium storing commands capable of being executed by a computer system. The commands may be stored in the form of program code. When the commands are executed by a processor, a program module is generated by the commands so that the operations of the disclosed embodiments may be carried out. The recording medium may be implemented as a non-transitory computer-readable recording medium.

The non-transitory computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the present disclosure have been shown and described, it would be appreciated by those having ordinary skill in the art that changes may be made in these embodiments without departing from the principles and spirit of the disclosure, the scope of which is defined in the claims and their equivalents.

In accordance with an aspect of the present disclosure, it may be possible to provide a vehicle and a controlling method thereof capable of providing efficient autonomous driving by changing the detection range and power consumption of the sensor or sensors according to the speed of the vehicle.

What is claimed is:

1. A vehicle, comprising:
an information acquirer configured to acquire vehicle surround information;
a speed sensor configured to acquire vehicle speed; and
a controller configured to determine vehicle stopping distance based on the vehicle speed and to determine a detection area for acquiring the vehicle surround information by the information acquirer based on the stopping distance and a risk level for each sensor channel,
wherein the detection area includes the stopping distance relative to the vehicle.

2. The vehicle according to claim 1, wherein the controller acquires the vehicle surround information by expanding the detection area to a predetermined extended detection area based on a speed increase of the vehicle speed and the risk level for each sensor channel when the vehicle speed exceeds a predetermined speed.

3. The vehicle according to claim 2, wherein the controller performs an autonomous driving algorithm based on the vehicle surround information acquired at the extended detection area.

4. The vehicle according to claim 1, wherein the controller acquires the vehicle surround information by reducing the detection area to a predetermined reduced detection area based on a speed decrease of the vehicle speed and the risk level for each sensor channel when the vehicle speed is less than a predetermined speed.

5. The vehicle according to claim 4, wherein the information acquirer includes a radar sensor and a lidar sensor, and wherein the controller performs a high precision autonomous driving algorithm by changing resolution of the radar sensor and the lidar sensor based on the vehicle speed and the risk level for each sensor channel when the vehicle speed is less than the predetermined speed.

6. The vehicle according to claim 4, wherein the controller reduces power consumed in acquiring the vehicle surround information to a predetermined value.

7. The vehicle according to claim 1, wherein the information acquirer includes at least one camera, and wherein the controller changes a maximum viewing distance of each camera of the at least one camera to a predetermined value corresponding to each camera of the at least one camera.

8. The vehicle according to claim 1, wherein the information acquirer obtains weather information of a road on which the vehicle travels, and wherein the controller determines the detection area based on the weather information and the vehicle speed.

9. The vehicle according to claim 1, wherein the information acquirer includes a first sensor and a second sensor, and wherein the controller determines a sensor determined risk level for each sensor channel that has a high risk as the first sensor, determines a sensor determined risk level for each sensor channel that has a low risk as the second sensor, and reduces the data acquisition area of the first sensor to a predetermined reduction area, and extends the data acquisition area of the second sensor to a predetermined extension range.

10. The vehicle according to claim 1, wherein the controller receives a vehicle driving mode from a user and determines a width of the detection area for acquiring the vehicle surround information based on the vehicle driving mode input by the user.
